(19) United States
(12) Patent Application Publication
(10) Pub. No.: US 2021/0342859 A1
(43) Pub. Date: Nov. 4, 2021

(54) SYSTEM AND METHOD FOR VIRTUAL INSPECTIONS

(71) Applicant: Anthony Perera, Cooper City, FL (US)

(72) Inventor: Anthony Perera, Cooper City, FL (US)

(21) Appl. No.: 17/244,921

(22) Filed: Apr. 29, 2021

Related U.S. Application Data
(60) Provisional application No. 63/017,656, filed on Apr. 30, 2020.

(51) Int. Cl. G06Q 30/00; H04L 29/06; H04W 4/021; H04L 29/08

(52) U.S. Cl. CPC G06Q 30/018; H04L 67/1097; H04W 4/021; H04L 65/4069

(57) ABSTRACT

A system and method to perform remote inspections that are geolocated via at least one of public records, preset addresses and verified location mapping for verifying that the inspected location is the correct location, with still photos and/or video that are date stamped and/or geo located.

### CROSS-REFERENCE TO RELATED APPLICATION

This application is related to and claims benefit to U.S. Provisional Patent Application Ser. No. 63/017,656, filed Apr. 30, 2020, entitled System and Method for Virtual Inspections, the entirety of which is incorporated herein by reference.

### FIELD OF THE INVENTION

The present invention relates to a system and method for remote inspection of properties, buildings, and locations using video conferencing and mobile device geolocation, and more particularly to a system and method for remote inspection of a permitted job to close permits.

### BACKGROUND OF THE INVENTION

Any time a person is remodeling, building, or changing a property for both commercial and/or residential property, the property owner must obtain a permit for the work. Throughout a permit process, various stages of the work being performed, or contemplated being performed, require an inspection. Either during the various stages of the work being performed or at the end of a project, the property owner must close out their permits. In order to close out a permit, a final inspection of the work must be inspected, generally by a city or county inspector.

For example, when a new AC unit is installed a property, a permit may be required. To close out the permit, the inspector may, for further example, check the equipment that was installed or the manner in which the equipment was installed, or that the job was performed. The inspector may further check the model and serial numbers of installed equipment to confirm that the changes to the property match the permit and that the work was performed to code.

In order to obtain a permit closure, traditionally, in-person inspections of a property are required. Due to travel time between properties, the inspectors spend a significant amount of time between jobs. Yet further, physical inspections are labor intensive, time-consuming, expensive, and limits the amount of possible daily inspections.

After an inspection has been completed, an inspector will sign a permit card on the premises only when the subject inspection is approved for closing the permit.

There is a need in the art for a system and method for remote permit inspections that inspections can use for remote inspections to close permits.

### SUMMARY OF THE INVENTION

The present invention advantageously provides a system and method for performing virtual geolocation data verified inspections, site walks, or other forms of visual verifications for permits and other applications that need an address verified for a specific location for video or photo verification.

According to an embodiment of the present invention, a principal object is to provide a system and method to perform remote inspections that are geo located via at least one of public records, preset addresses and verified location mapping.

According to an embodiment of the present invention, another object is to provide a remote inspection system and method that allows the inspection to take place when an electronic device is located at the address of the inspection and does not allow the inspection to start, continue, and/or finish if the electronic device is not geolocated at the address location.

According to an embodiment of the present invention, another object is to provide a remote inspection system and method that alerts a remote inspector if the electronic device used to provide camera data is not located at the inspection location.

According to an embodiment of the present invention, another object is to provide a remote inspection system and method that takes still, date stamped, and geo located photos at the location of the remote inspection location to be stored in the remote inspection system and/or public records database.

Yet another object of the present invention is that during the live geolocated video conference, the still photos can be taken from the video itself in live format and both the video and photos are date stamped and geo located.

Yet another object of the present invention is to provide a system and method of virtual inspection of a permit location performed on a non-transitory computer-readable medium that comprises providing a virtual inspection control panel for displaying a virtual permit inspection of one or more mobile device, acquiring geolocation data from one or more mobile device, automatically comparing the geolocation data from the one or more mobile device against the permit location, confirming the location of the one or more mobile device against the permit location, and displaying an indictor on the virtual inspection control panel indicating whether the first mobile device is located within a proximity to the permit location.

Yet another object of the present embodiment is to provide a system and method of virtual inspection of a permit location performed on a non-transitory computer-readable medium that comprises receiving to the virtual inspection control panel a live video stream from a camera located on one or more mobile device.

In yet another object of the present embodiment, the virtual inspection includes selecting to start of the virtual inspection and automatically notifying on one or more mobile device of the start of the virtual inspection upon said selection of the start of the virtual inspection, from which the one or more mobile device may be able to connect with the virtual inspection via a web based application, a mobile application, peer-to-peer, or any other system or method able to connect the control panel with the live stream with one or more one mobile device.

In yet another embodiment of the present invention, the virtual inspection control panel includes an inspection notes section, where the provided inspection notes section includes a camera shutter feature to store a live geolocated picture from the camera of the first mobile device, and the provided inspection notes section includes at least one individual notes section with a selectable portion capable of indicating one of at least pass and fail, the provided notes inspection section further includes a plurality of notes sections each with an option to take a live geolocated picture from the camera of the first mobile device and where each of the plurality of notes sections include a selectable portion capable of indicating pass and/or fail.

In yet another aspect of the present invention, a system and method of virtual inspection of a permit site performed on a non-transitory computer-readable medium is provided for using a virtual inspection control panel for displaying a virtual permit inspection of one or more mobile device, acquiring geolocation data from a first mobile device, automatically determining whether the one or more mobile device are located within a predetermined virtual permit inspection site. Once the system automatically determines whether the one or more mobile device are located with in the predetermined virtual permit inspection site, the system may optionally indicate through the virtual inspection control panel whether the one or more mobile device are properly located within the physical inspection site. Optionally, the location of the geolocation of one or more mobile device may be stored to a cloud storage site indicating of whether each of the one or more mobile device were located within the predetermined virtual permit inspection site during at least a portion of the virtual inspection. The virtual inspection control panel provides an annotation section for annotating captured pictures from the first mobile device.

In yet another aspect of one embodiment of the present invention includes a camera roll within the virtual inspection control panel, wherein the virtual inspection control panel is capable of taking live geolocated pictures from the camera of the one or more mobile device taken during the virtual inspection. The virtual inspection control panel includes selectable indicia capable of indicating at least between a pass and fail of the virtual inspection. The virtual inspection control panel includes a live geolocated video feed section displaying live video received from a camera on the first mobile device. The virtual inspection control panel capable of initiating an on/off of a light on one or more mobile device located at the inspection site.

In yet another object of one embodiment of the present invention, the system for virtual inspection of a permit location includes a report generation portion that automatically provides a downloadable report following a conclusion of the virtual inspection.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a block diagram of an exemplary remote booking system in accordance with the principles of the present embodiment;

FIG. 2 is a block diagram of an exemplary computing device described herein in accordance with the principles of the present embodiment;

FIG. 3 is the mobile device in FIG. 1 with an exemplary scheduling display home screen in accordance with the principles of the present embodiment;

FIG. 4 is the mobile device in FIG. 1 with an exemplary scheduling display home screen with additional expanded information in accordance with the principles of the present embodiment;

FIG. 5 is the mobile device in FIG. 1 with an exemplary scheduling display screen with date and time selection options in accordance with the principles of the present embodiment;

FIG. 6 is the mobile device in FIG. 1 with a scheduling confirmation display screen in accordance with the principles of the present embodiment;

FIG. 7 is the mobile device in FIG. 1 with an exemplary scheduling display home screen displaying two scheduled inspections in accordance with the principles of the present embodiment;

FIG. 8 is the mobile device in FIG. 1 with an exemplary scheduling display home screen displaying expanded inspection options in accordance with the principles of the present embodiment;

FIG. 9 is the mobile device in FIG. 1 during an exemplary inspection in accordance with the principles of the present embodiment;

FIG. 10 is an inspection schedule in accordance with the principles of the present embodiment;

FIG. 11 is an inspection control panel in accordance with the principles of the present embodiment;

FIG. 12 is a flow chart of an exemplary remote inspection process in accordance with the principles of the present embodiment;

FIG. 13 is a flow chart of an exemplary remote inspection process for remote inspection scheduling in accordance with the principles of the present embodiment;

FIG. 14 is a flow chart of an exemplary remote inspection process for documenting a remote inspection in accordance with the principles of the present embodiment;

FIG. 15 is a remote inspection system with a permit creation section in accordance with the principles of the present embodiment;

FIG. 16 is a remote inspection system with a permit application entry portion in accordance with the principles of the present embodiment;

FIG. 17 is a remote inspection system with a permit application entry portion having a drop down menu in accordance with the principles of the present embodiment;

FIG. 18 is a remote inspection system with a permit application entry portion having job information section in accordance with the principles of the present embodiment;

FIG. 19 is a remote inspection system with a permit application entry portion having property and contractor information sections in accordance with the principles of the present embodiment;

FIG. 20 is a remote inspection system with a permit application entry portion having at least one inspection type selection in accordance with the principles of the present embodiment;

FIG. 21 is an inspector calendar display with a toggle view between disciplines in accordance with the principles of the present embodiment;

FIG. 22 is an inspector control panel with initiation of virtual inspection button displayed in accordance with the principles of the present embodiment;

FIG. 23 is an inspector control panel with geolocation verification of a mobile device displayed in accordance with the principles of the present embodiment;

FIG. 24 is an inspector control panel with geolocation map verification of a mobile device in relation to an inspection site in accordance with the principles of the present embodiment;

FIG. 25 is an inspector control panel with a notes section in accordance with the principles of the present embodiment;

FIG. 26 is an inspector control panel with a single notes area added having a status indictor in accordance with the principles of the present embodiment;

FIG. 27 is an inspector control panel with a multiple note areas added each having a status indictor for pass/fail type indicators in accordance with the principles of the present embodiment;

FIG. 28 is an inspector control panel with a pass/fail type status section for each note area in accordance with the principles of the present embodiment;

FIG. 29 is an inspector control panel showing a camera roll portion in accordance with the principles of the present embodiment;

FIG. 30 is an inspector control panel annotation portion for annotating camera roll pictures in accordance with the principles of the present embodiment;

FIG. 31 is an inspector control panel displaying annotated pictures in the camera roll in accordance with the principles of the present embodiment;

FIG. 32 is an inspector control panel displaying a light toggle in accordance with the principles of the present embodiment;

FIG. 33 is an inspection confirmation area for confirming the end of a virtual inspection in accordance with the principles of the present embodiment;

FIG. 34 is an inspection calendar displaying an exemplary passed inspection in accordance with the principles of the present embodiment;

FIG. 35 is an inspector control panel displaying indicia indicating that video of a virtual inspection is saving in accordance with the principles of the present embodiment; and

FIGS. 36-39 display a report automatically created following a virtual inspection in accordance with the principles of the present embodiment.

### DETAILED DESCRIPTION OF THE INVENTION

The present invention advantageously provides a system and method remote inspection of properties, buildings, and locations using video conferencing and mobile device geolocation, and more particularly to a system and method for remote inspection of a permitted job to close permits. The present invention contemplates various types of remote inspection and permit closing applications, as well as other job site or address specific inspections and/or verifications.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It is understood that the term “location” in reference to location data as used herein can represent an address, a folio, or other information and/or data that can be used to identify the location of a mobile device in relation to a physical location.

It is understood that the term “proximity” in relation to the proximity to the remote inspection location as used herein can represent a radius, a distance to a specific point, a distance to a specific address or set of addresses, and/or any other proximity that can be calculated in relation to a mobile device and an inspection location.

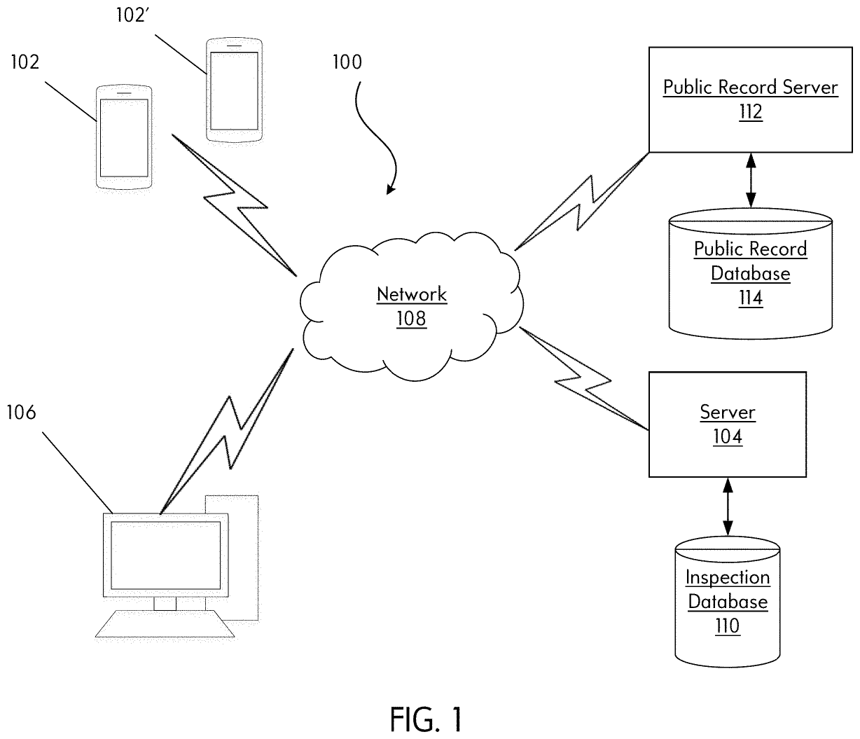

Referring now to the drawings figures in which like reference designators refer to like elements. FIG. 1 is a block diagram of an exemplary embodiment of a remote inspection system constructed in accordance with the principles of the present invention and designated generally as remote inspection system 100. In particular, the remote inspection system 100 may comprise hardware and/or software that conduct various operations for booking, scheduling, and facilitating a remote inspection and optionally for closing permits via the remote inspection and geolocating mobile device at the time of the inspection to verify remote inspection location. In this embodiment, the remote inspection system 100 includes one or more mobile devices (e.g., mobile device 102), one or more servers (e.g., server 104), one or more computers and/or tablets (e.g., inspector device 106) and/or one or more networks (e.g., network 108).

Mobile device 102 may be any computing device (including without limitation smart phones, smart device, tablets) with which a user (e.g., homeowner, contractor, electrician, HVAC employee, or vacation rental property owner) may have user interaction, including without limitation a mobile phone (e.g., a smart phone, including without limitation iPhones and Android phones) or a tablet computer. Mobile device 102 may send and/or receive data to and/or from other devices and systems in FIG. 1, including through network 108. While a single mobile device 102 is depicted in FIG. 1, the remote inspection system 100 may include a large number of mobile devices for large inspections or inspections utilizing multiple persons to facilitate the inspection remotely through the remote inspection system 100 through the network 108. Any mobile device that has access to network 108 may be able to communicate with the server 104 and/or inspector device 106 and/or other mobile device 102′.

Inspector device 106 may be any computing device (including without limitation any smart device, desktop computer, and tablets).

Network 108 may include, without limitation and for exemplary purposes, the Internet, an intranet, a cellular carrier network, a landline telephone network, a local area network (LAN), a wireless local area network (WLAN, and/or a dedicated connection. The plurality of mobile devices 102, inspector device 106, and servers 104 may communicate directly or indirectly over the network 108.

Server 104 as exemplified in FIG. 1 may represent a single device (such as a single computer) or multiple devices (such as multiple computers) and/or one or more cloud based servers (such as AWS, Azure, Google Cloud, or etc.). Server 104 may be configured to communicate with the mobile devices 102 and/or inspector device 106, and respond based on information stored in the server 104 or another internal or external library, including cloud storage.

The one or more mobile device 102 may provide information to another connected device 102, 104, 106, including video and/or geolocation data.

The one or more mobile devices 102, the one or more inspector device 106, and the one or more servers 104 each include one or more non-transitory tangible computer-readable media storage, such as one or more solid state drives, optical drives, magnetic drives, tape drives, and/or other types of hard drives and/or memory capable of storing data.

The server 104 may include an inspection database 110. The inspection database 110 may each include one or more non-transitory tangible computer-readable media storage, such as one or more solid state drives, optical drives, magnetic drives, tape drives, and/or other types of hard drives and/or memory. The one or more computer-readable media of inspection database 110 may store information from remote inspections performed during remote inspection sessions with one or more mobile devices 102.

The user account may be referenced interchangeably herein as an account or as the device on which the account is accessed, including any of mobile device 102 and inspector device 106.

The public record server 112 may include a public record database 114. The public record database 114 may each include one or more non-transitory tangible computer-readable media storage, such as one or more solid state drives, optical drives, magnetic drives, tape drives, and/or other types of hard drives and/or memory. The one or more computer-readable media of public record database 114 may store public record information including without limitation as open and/or closed permit status, folio information, property owner information, geolocation data, building information, license numbers, license types, landscape information, enforcement information, planning information, contractor license information, applicant information, project description, payment and fee information, and owner information.

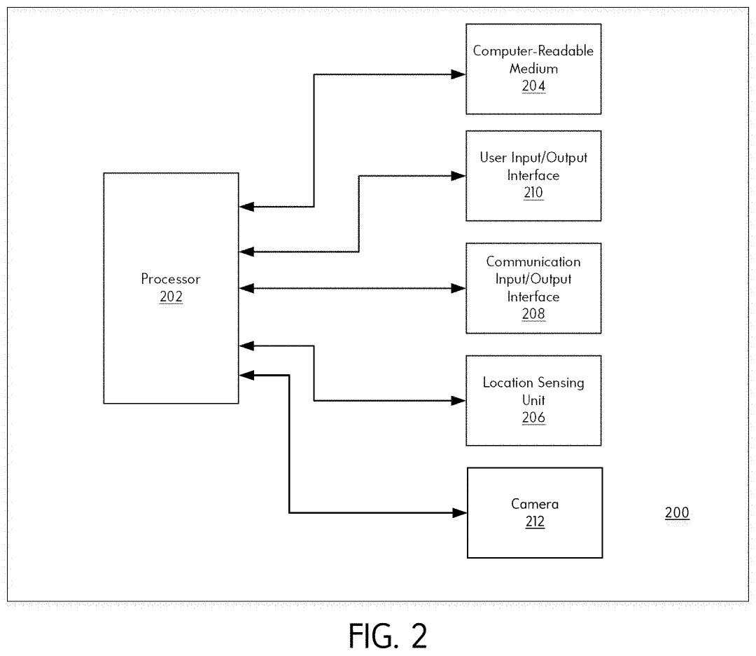

Referring now to FIG. 2, a block diagram is shown of an exemplary computing device 200 that may be used to embody, either partially or fully, each of any of the one or more mobile device 102, inspector device 106 and the server 104. Computing device 200 may include hardware and software. The hardware may execute software to perform functions thereof. The software, if any, may be executed via a processor 202 and the software may be stored on a tangible non-transitory computer-readable medium 204. Computing device 200 may read those computer-readable instructions, and in response perform various steps as instructed by the computer-readable instructions. Accordingly, any steps, functions, calculations, device, and other elements described herein may be implemented by a computer, such as by reading and executing computer-readable instructions for performing those functions, and/or by any hardware, such as processor 202, from which computing device 200 is composed. Additionally, or alternatively, any of the above-mentioned functions may be implemented by the hardware of computing device 200, with or without the execution of software. The computing device 200 may include microprocessors, central processing units (CPUs) and/or other types of elements capable of performing some or all of the functions attributed to the computing device 200.

Processor 202 may process user input data, including data entered via a touch screen device or via verbal instructions, or via information received on the computing device 200 via an outside source over the network 108.

Computer-readable medium 204 may include a single physical non-transitory medium, or a combination of one or more such non-transitory medium, which may include without limitation solid state drives, hard drives, memories, optical discs (e.g., CDs or DVDs), magnetic discs, and magnetic tape drives. The computer-readable medium 204 may be a physical component of the computing device 200, or may alternatively be a remote component accessible by the computer device 200 over the network 108, including read/write functionality.

Computing device 200 may include a communication input/output interface 208 for facilitating communication of the computing device 200 across the network 108 to communicate with the server 104 and/or other computing device 200.

Computing device 200 may include a location sensing unit 206 capable of receiving and/or determining the location of the computing device 200, particularly when the computing device embodies the either of one or more of mobile device 102. The location sensing unit 206 may include a global-positioning system (GPS) but is not so limited. The location sensing unit 206 may utilize a combination of software and hardware to locate a local computing device 200 or may be utilized to locate a remote computing device 200.

Computing device 200 may also include user input/output interface 210 for receiving input from a user (e.g. via a virtual/digital keyboard, physical keyboard, mouse, audio microphone, document upload, touchscreen, remote control and/or other input elements), camera 212 and providing output to the user (e.g., a digital display, touchscreen display, audio speaker, piezoelecric element, printer, and/or other output elements). The processor 202 may cause a variety of inputs and outputs and or the display of information to the user and/or providing interactive data for a user including providing user communications, interactions, and a variety of data over the network 108.

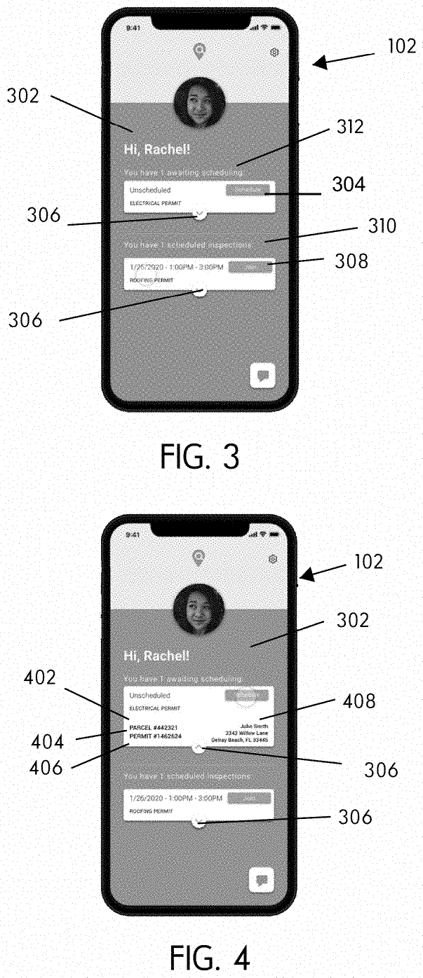

Referring now to FIG. 3, is representative of a system and process performed by an exemplary user application on one or more mobile device 102. The mobile device 102 includes a user interface that provides the user with a user control panel 302 that displays on the mobile device 102 with user selection options. In a non-limiting embodiment, the user selection options include without limitation a schedule selection option 304, an expend selection option 306, and a join selection option 308. The user application provides a list of the scheduled 310 and unscheduled 312 remote inspections.

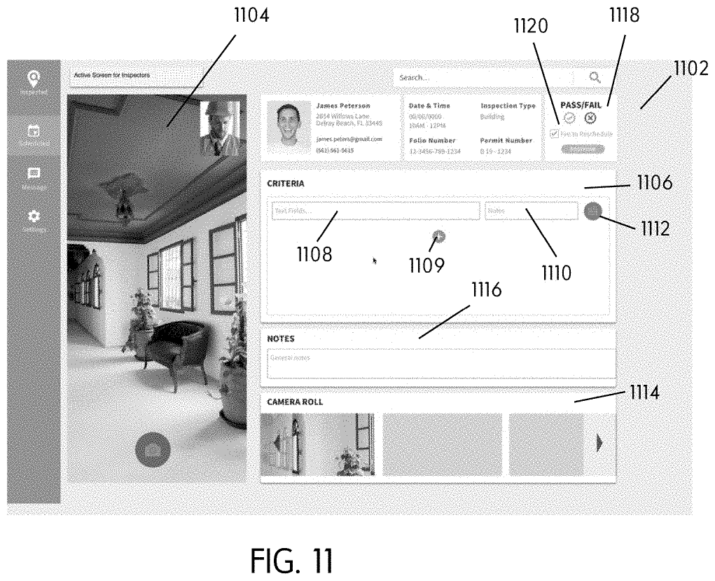

As exemplified by FIG. 3, the remote inspection system 100 describes a system where the user previously scheduled 1 remote inspection and 1 remote inspection is awaiting for the user to schedule a remote inspection. The screen shot of FIG. 3 is merely exemplary and in operation the system can include any number of scheduled and/or unscheduled remote inspections between zero to unlimited positive number of items in the list for either or both of the scheduled list 310 and the unscheduled list 312 of remote inspections. The remote inspection system 100 provides the ability to cancel and/or reschedule a scheduled inspection found on the scheduled list 310, as further discussed in conjunction with FIG. 8 herein.

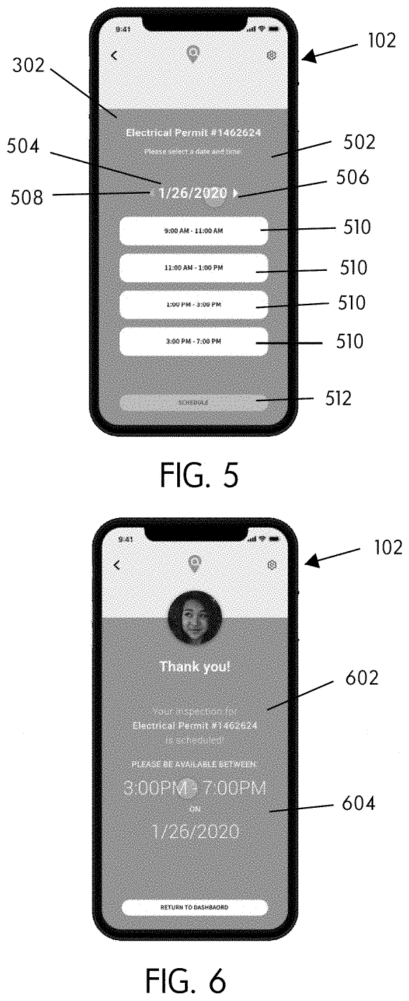

Referring now to FIG. 4, the user control 302 provides the user application with one unscheduled inspection expanded 402 to provide additional details including without limitation a parcel number 404, a permit number 406, and user information 408, including address and name information. In an example of the operation, the user in FIG. 4 selected the expand selection option 306 from the unscheduled list 312 from FIG. 3, causing the display of the expanded information related to the permit.

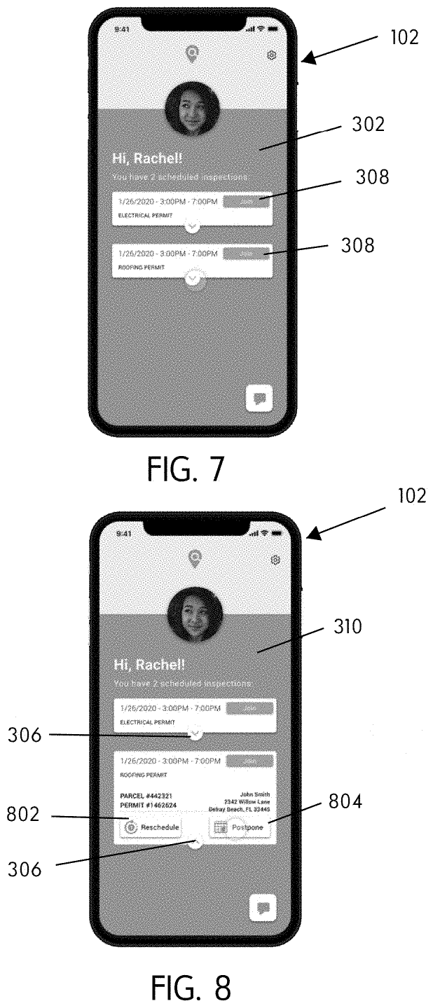

Referring now to FIG. 5, the user control 302 provides the user application with the schedule selection option 304 from FIG. 3 selected now displaying a date and time selection portion 502. The date and time selection portion 502 is associated one or more available and selectable time slots 510 from a list of available remote inspection time slots. The user, via the mobile device 102, is provided with a date and time selection portion 502, allowing the user to scroll right 506 and left 508 between available remote inspection dates, and associated one or more available and selectable time slots 510 from a list of available remote inspection time slots. Selecting one of the one or more available and selectable time slots 510 will allow a user to select schedule 512 for scheduling a remote inspection.

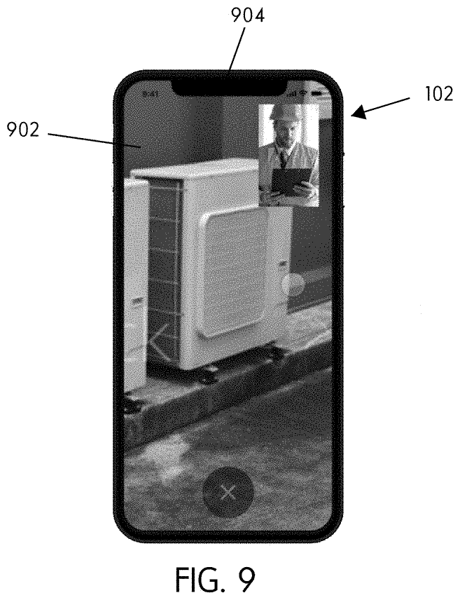

Referring now to FIG. 6, remote inspection selection information 602 information is displayed on the mobile device 102 after a date and time is selected from the screen in FIG. 5 via the selected schedule 512 option. The remote inspection selection information 602 may include corresponding information, such as a confirmation of an inspection for a particular permit number that displays on the mobile device 102.

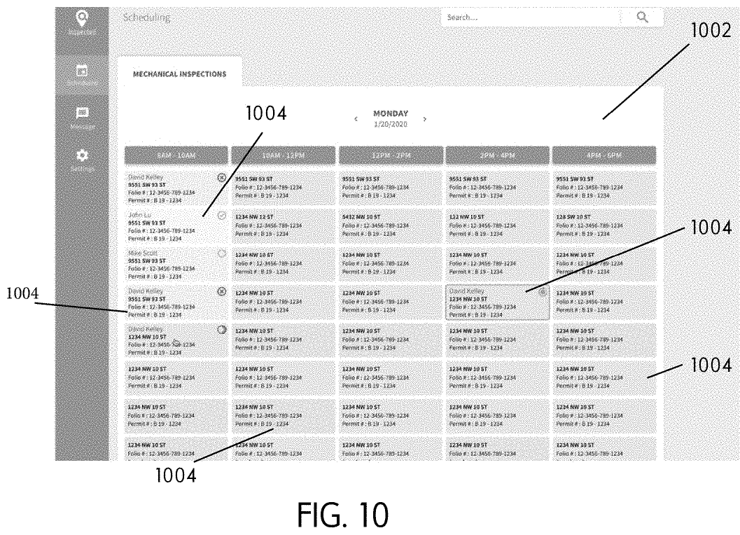

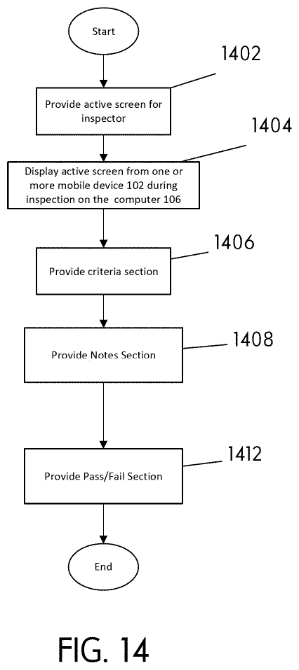

Referring now to FIG. 7, the user via the user control panel 302 may be presented with a screen that identifies the scheduled inspections subsequent to the scheduling steps described exemplified in FIGS. 3-7. In operation, the user control panel 302 is provided with two exemplary scheduled inspections (one for an electrical permit and one for a roofing permit) allowing the user to select join 308 for the inspection that the user seeks to join. When the user selects join 308 for one of the scheduled remote inspections, the users camera will display video from the camera of the mobile device 102 to the active screen 1104 of FIG. 11, described infra.

In one non-limiting embodiment, when a user selects join 308, a geo location routine is performed. The geo location routine compares the geo location of the mobile device 102 seeking to join the remote inspection.

In a non-limiting embodiment, the remote inspection system 100 will allow the mobile device 102 seeking to join the remote inspection only when the geo location data from that mobile device 102 corresponds with the location of the remote inspection address. Likewise, when the remote inspection system 100 determines that the mobile device 102 seeking to join the remote inspection is not located at the location and/or within a specified proximity to the physical location of the remote inspection, the remote inspection system 100 will not allow the mobile device 102 to join the remote inspection.

In a non-limiting embodiment, when the remote inspection system 100 determines that the mobile device 102 seeking to join the remote inspection is determined to be outside of the location and/or set proximity of the remote inspection, the remote inspection system 100 will not allow the mobile device 102 to join the remote inspection and/or notify the other member(s) in the inspection that the device is not at the specified location, including notifying on the inspector device 106.

In a non-limiting embodiment, when the remote inspection system 100 determines that the mobile device 102 seeking to join the remote inspection is determined to be outside of the location and/or set proximity of the remote inspection, the remote inspection system 100 will notify the inspector.

In a non-limiting embodiment, when the remote inspection system 100 determines that the mobile device 102 seeking to join the remote inspection is determined to be outside of the location and/or set proximity of the remote inspection, the attempt to join from outside of the location and/or proximity to the remote inspection is stored, such as in the inspection database 110.

In a non-limiting embodiment, when the remote inspection system 100 determines that the mobile device 102 seeking to join the remote inspection is determined to be outside of the location and/or set proximity of the remote inspection, the mobile device 102 seeking to join the remote inspection is alerted of the rejection to join the remote inspection. In another non-limiting embodiment, the mobile device 102 displays the rejection to join the remote inspection on the screen to the user.

In a non-limiting embodiment, when the remote inspection system 100 determines that the mobile device 102 seeking to join the remote inspection is determined to be outside of the location and/or set proximity of the remote inspection, the mobile device 102 displays directions to aid the user move the mobile device 102 into the correct location and/or proximity to join the remote inspection.

In a non-limiting embodiment, when the remote inspection system 100 determines that the mobile device 102 that is connected during the remote inspection moves outside of the location and/or proximity of the remote inspection location, the user and/or the inspector is alerted via the mobile device 102 and/or the inspector device 106. Yet further in this non-limiting embodiment, the inspection control panel 1102 may receive an alert or indication that may optionally be stored to the permit file regarding the irregular location data.

Referring now to FIG. 8, the user is provided with the expand selection option 306 selected on the mobile device 102 from the list 310 of scheduled inspections for providing additional user options. In this embodiment, user selection of the expand selection option 306 provides the user with a reschedule selection option 802 and a postpone selection option 804. When the reschedule 802 option is selected by the user, the user will be provided with the opportunity to reschedule the inspection as described by processes in FIGS. 3-6. When the postpone 804 option is selected by the user, the scheduled inspection will move from the scheduled list 310 to the awaiting schedule list 312, at which point the user will be able to reschedule the inspection at a later date as described by the processes in FIGS. 3-6.

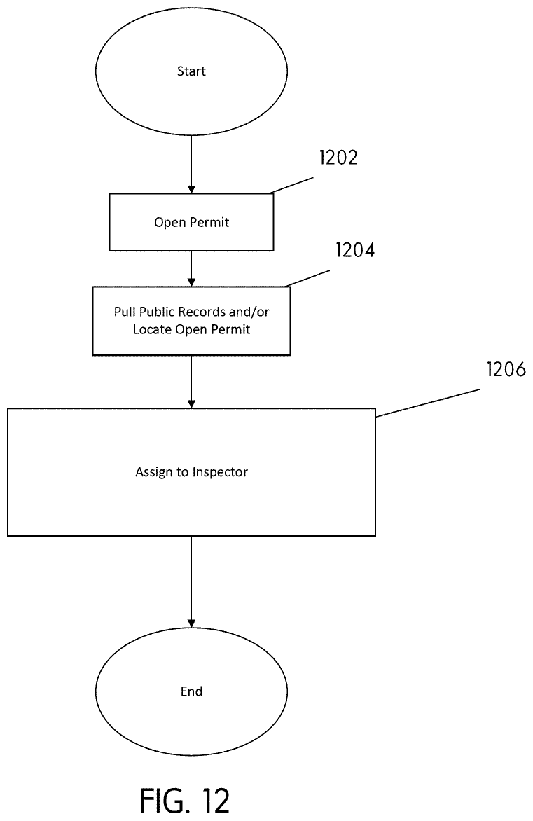

Referring now to FIG. 9, a shared video call with live video 902 and audio 904 from the mobile device 102 during a remote inspection is provided. The shared video call of FIG. 9 provides a remote inspector video stream 906 for live viewing of the remote inspector during the remote inspection that was joined by selecting join 308 from FIG. 7. Unlike prior video calls, the instant remote inspection system 100 compares geo location data with a location, such as a property address, to ensure that the mobile device 102 is located at the inspection site to prevent fraudulent remote inspections.

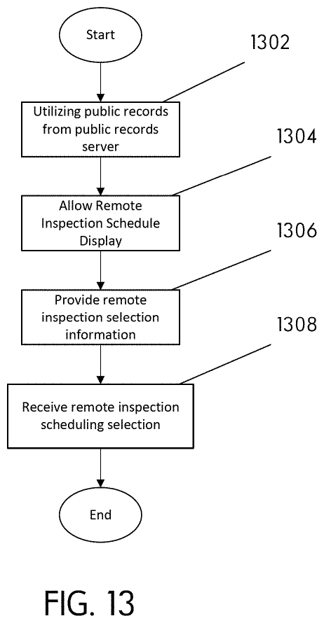

Referring now to FIG. 10, an inspector calendar 1002 is provided for display on inspector device 106. The inspector calendar 1002 allows the selection of the remote inspector join selection option 1004 for entering into an inspection control panel 1102 on an inspector device 106 of FIG. 11, described infra. A remote inspection of the scheduled remote inspections inspector provides an address panel that the remote inspector can select for entering a live control panel for a live inspection. When the remote inspector selects a calendar date via the join selection option 1004, the inspector device 106 will enter the inspection control panel 1102.

Referring now to FIG. 11, the inspection control panel 1102 is provided for remotely inspecting a property to pass or fail an attempt to close a permit. The inspection control panel 1102 includes an active screen 1104 with live video from the mobile device 102 (FIG. 9) of the user located at the inspection site for allowing the remote inspector to live view the inspection site.

The inspection control panel 1102 includes a criteria section 1106. The criteria section 1106 includes one or more customizable fields per inspection type. For example, the custom fields may be different for an HVAC inspection versus a mechanical inspection versus an electrical inspection.

The inspection control panel 1102 includes a criteria notes section. The criteria notes section 1110 is associated with the one or more customizable fields 1108. The customizable fields 1108 can receive address data, inspection criteria or other information related to the inspection. The customizable fields 1108 may be setup by an admin panel (not shown) or the individual creating the inspection either during time of the inspection or prior to the inspection. The criteria notes section 1110 allows the remote inspector to place notes related to the one or more customizable inspection fields 1108. For example, the remote inspector may make notes that ultimately relate to the pass or fail of the inspection. Additional rows of the customizable fields 1108, criteria notes section 1110 and camera capture 1112 may be generated by selected the customizable field row plus button 1109 and will populate below the prior row.

The inspection control panel 1102 includes a camera capture 1112 for capturing video from the camera of the mobile device 102 as displayed in the active screen 1104. The camera capture 1112 feature is provided with the criteria selection to allow the remote inspector to capture a still photo and/or video clip from the live view of the one or more mobile device 102 and associate the capture with the customizable inspection fields 1108. The photo captures and/or video clips that are taken from the active screen 1104 are saved into the camera roll 1114. The camera roll 1114 may be accessed to view any image and/or video clip captured during the entire inspection.

In one non-limiting embodiment, the user of the mobile device 102 can capture photos and/or video that are automatically stored to the camera roll 1114 and/or customer profile and/or address record.

The inspection control panel 1102 provides a general notes section 1116 for remote inspection note taking. In operation, the inspector may wish, for example, to take general notes that are unrelated to specific customizable fields. Thus, the general notes section 1116 provides for general remote inspection notes.

In a non-limiting embodiment, the inspection control panel 1102 provides a pass/fail selection portion 1118. The remote inspector may select between pass or fail. A failed inspection will allow one or more options for rescheduling a subsequent inspection. While the instant non-limiting embodiment provides for a pass/fail selection portion 1118, other true/false type operations may be implemented in place of the pass/fail selection portion 1118 such as complete/incomplete, verified/not verified, performed/not performed, and inspected/not inspected.

In one non-limiting embodiment, the remote inspector has to option to select via a selection indicia 1120 whether the user of the mobile device 102 will be charged a fee to reschedule and/or reinspect the permitted job.

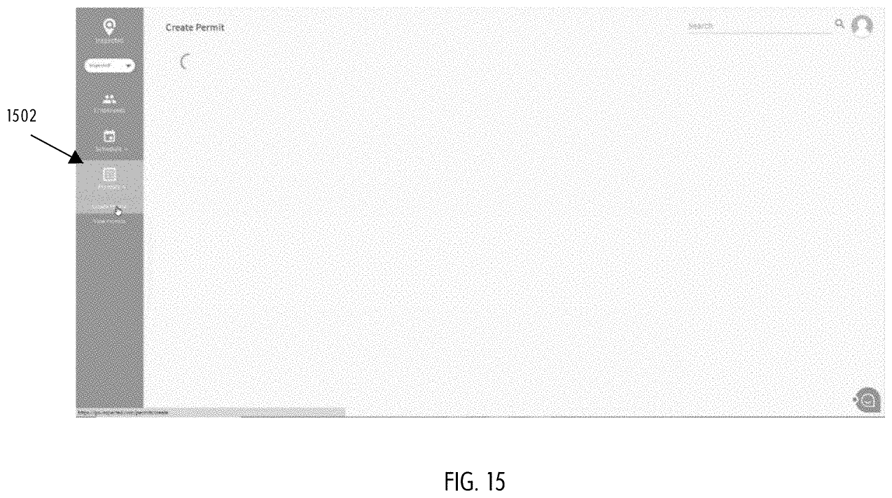

Referring now to FIG. 12, is a flow chart of an exemplary remote inspection process in accordance with the principles of the present embodiment. At block 1202, a permit is opened, such as with a local city or county. The public record server 112 outputs public records from the public record database 114, including without limitation open and/or closed permit status, folio information, property owner information, geolocation data, building information, license numbers, license types, landscape information, enforcement information, planning information, contractor license information, applicant information, project description, payment and fee information, owner information, and inspection type.

Still at block 1202, the remote inspection system 100 receives open permit information from the public record server 112 (FIG. 1). At Block 1204, the received public records from the public record server 112 are displayed to a user.

In one non-limiting embodiment, an application for a permit will be received and cause the opening of the permit. At block 1206, the open permit will be assigned to an inspector and/or a group of inspectors.

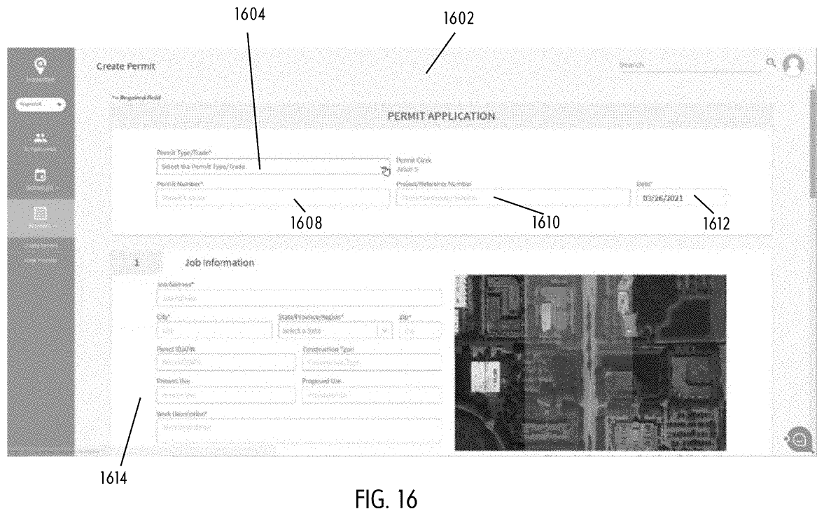

Referring now to FIG. 13, is a flow chart of an exemplary remote inspection process for remote inspection scheduling. At block 1302, the remote inspection system 100 utilizes public records from the public records server 112 for scheduling a remote inspection.

In one non-limiting embodiment, the remote inspection system 100 utilizes public records in real-time from the public records database 114. In another non-limiting embodiment, the remote inspection system 100 utilizes previously stored information from the public records database 114 to the inspection database 110, thereby utilizing the information from the inspection database 110.

At block 1304, the remote inspection system causes schedule information to display to a user on one or more mobile device 102. The displayed inspection schedule correlates to a permit, including a folio and/or physical address, owner, and/or permit applicant. The display of schedule information to the user allows the user on one or more mobile device 102 to schedule a remote inspection with a remote inspector. The user, via the mobile device 102, is able to select the schedule selection option 304 (FIG. 3). At block 1306, once selected the user on the mobile device 102 chooses the inspection date and time, the user will then select schedule 512 (FIG. 5) on the mobile device 102 thereby providing the user via the mobile device 102 remote inspection selection information 602 (FIG. 6). The remote inspection selection information 604 (FIG. 6) in an embodiment is displayed to the user on the display of the mobile device 102. At block 1308, the server 104 receives from the mobile device 102 the remote inspection selection information 604. The remote inspection selection information 604 is assigned to the inspector calendar 1002 for a remote inspector inspection.

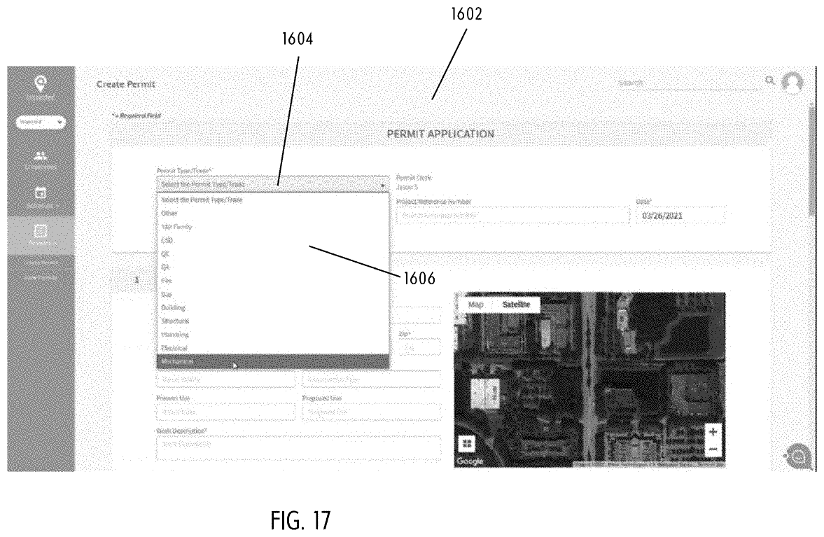

Referring now to FIG. 14, is a flow chart of an exemplary non-limiting remote inspection process for video, photo, and/or geo location documenting a remote inspection. At block 1402, a remote inspector utilizes an inspection control panel 1102 on a inspector device 106. An active screen 1104 within the inspection control panel 1102 with live video is provided to a remote inspector for live viewing of the remote inspection. The remote inspector will be able to communicate with the remote user at the physical location that matches the permit location found in the permit application via live video 902 and audio 904 from the mobile device 102. Likewise, the user will be able to receive video from the inspector device 106.

At block 1404, the active screen 1104 is displayed from one or more mobile device 102 during the remote inspection on the inspector device 106 to allow a remote inspector to live view and/or record the inspection site. In a non-limiting operation, the inspector may provide instructions for the user to adjust the mobile device to allow the camera on the mobile device to share/capture appropriate camera footage.

At block 1406, a criteria section 1106 is provided. The criteria section 1106 includes one or more customizable fields per inspection type. For example, the custom fields may be different for an HVAC inspection versus a mechanical inspection versus an electrical inspection.

The camera capture 1112 feature is provided during the remote inspection to allow the remote inspector to capture a still photo and/or video clip from the live view of the one or more mobile device 102. The photo captures and/or video clips that are taken are saved into the camera roll 1114 and optionally include geo location data.

At block 1408, the general notes section 1116 is provided for remote inspection note taking. The inspector may wish, for example, to take general notes that are unrelated to specific customizable fields.

At block 1412, the inspection control panel 1102 provides a pass/fail selection portion 1118. The remote inspector may select between pass or fail.

The remote inspection system 100 automatically geotags and cross references the location of the mobile device 102 before, during and/or at the conclusion of the remote inspection.

The inspection control panel 1102 alerts the remote inspector when geolocation of the mobile device does not correlate with the geolocation found in the permit and/or permit application.

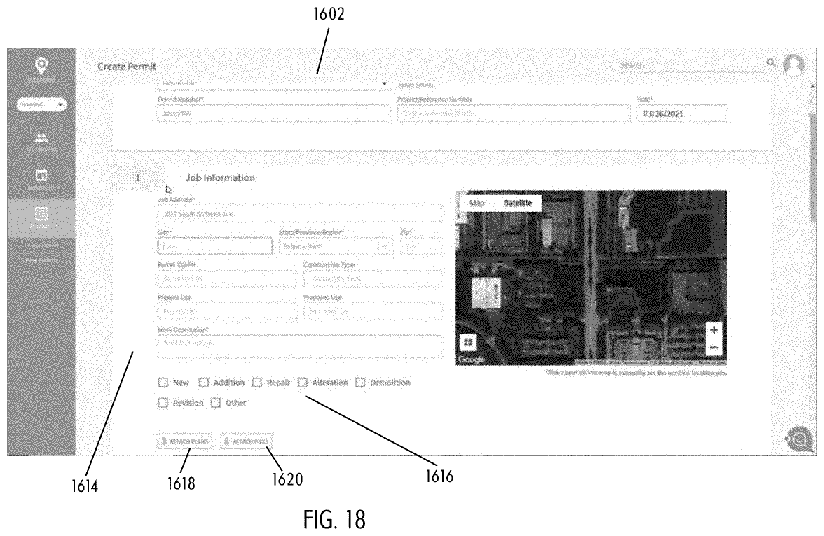

Referring now to FIG. 15, a permit creation section 1502 is provided with a first permit selectable portion 1504 to create a permit and a second permit selection portion 1506 to view permits a previously created. Selecting the first permit selectable portion 1504 will bring up a screen for entering/creating a permit into the system. Selection the second permit selection portion 1506 will provide a list of permits that were previously populated into the system.

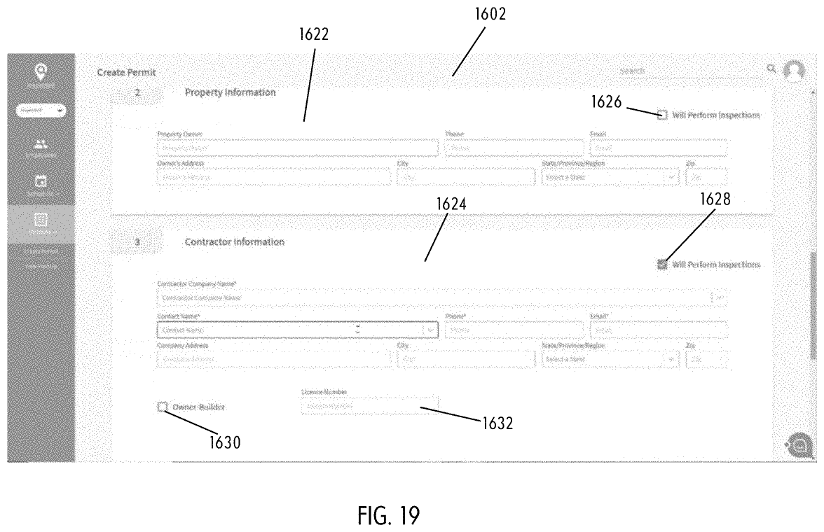

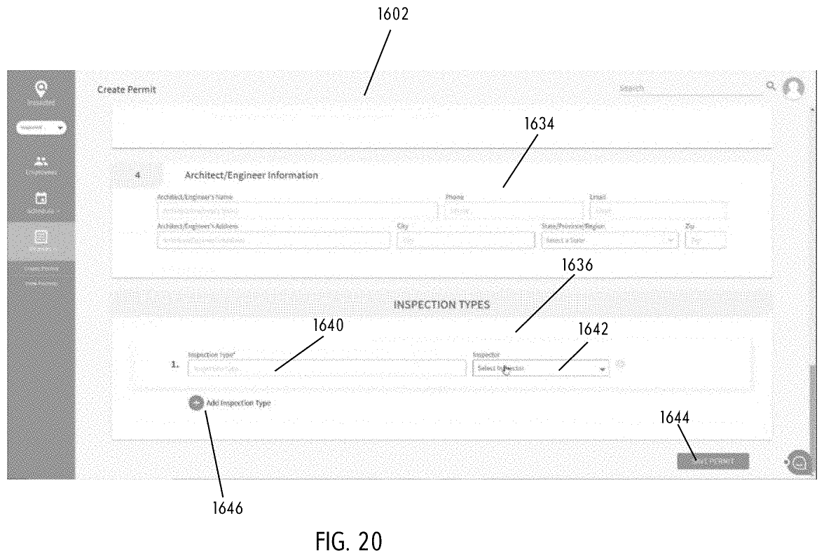

Referring now to FIGS. 16-20, a permit application entry portion 1602 is provided on a computer. The permit application entry portion 1602 includes a permit type selection portion 1604 with a dropdown selection area 1606. A user may select the type of permit being sought. For exemplary purposes, the selection area 1606 of the permit type selection portion 1604 allows for the selection of the type of permit, such as a building permit, structural permit, plumbing permit, electrical permit, mechanical permit, fire permit, gas permit, or other permit (See FIG. 17). The permit application entry portion 1602, in a non-limiting embodiment, includes a permit number entry portion 1608 for entering a permit number to be associated with an address and/or folio. The permit application entry portion 1602 includes a project/reference number that can be assigned to the project.

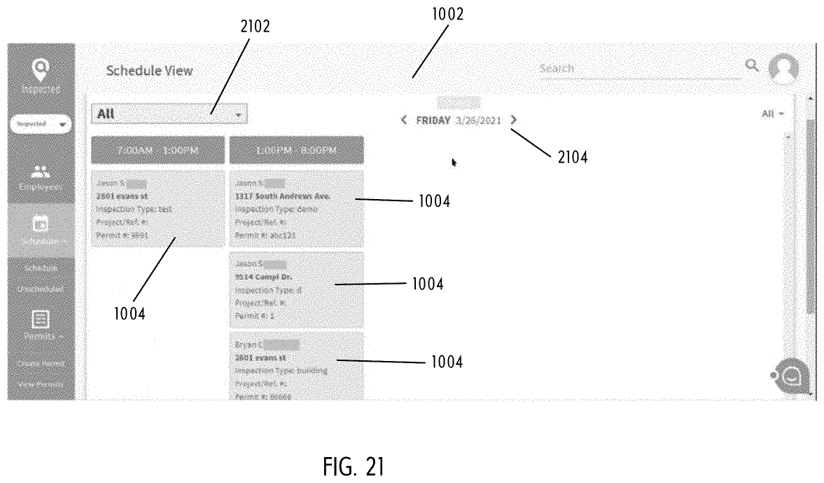

Referring now to FIG. 18, the permit application entry portion 1602 includes an area for a date. The permit application entry portion 1602 in a first section further includes the job information section 1614 that includes entry areas for information such as the parcel ID, construction type, present use, proposed use, and a description of the work to be performed under the permit (See FIGS. 16 and 18). The job information section 1614 further includes selection boxes 1616 such as whether the job is new, an addition, a repair, an alteration, a demolition, a revision, or something other (See FIG. 18). The job information section 1614 includes a plan attachment areas 1618 where a user can attach one or more job plans to be included and saved with the permit being created and a file attachment area 1620 where a user can attach one or more files to also be included during the creation of the permit application.

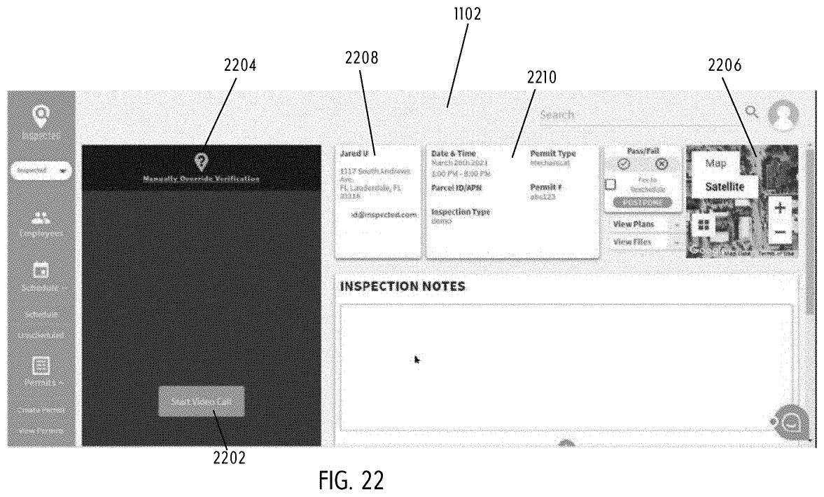

Referring now to FIG. 19, the permit application entry portion 1602 includes a property information section 1622 that includes the property owner information such as the name of the property owner, a phone number, an email, and an address. The permit application entry portion 1604 further includes a contractor information section 1624 for entry of the contractor information associated with the permit. The property information section 1622 and the contractor information section 1624 includes selection boxes 1626, 1628 that may be selected to indicate the person and/or persons that will perform the virtual inspection such that the correct person(s) are contacted at and/or before the time of the inspection with virtual inspection instructions. The contractor information section 1624 includes a check box 1630 to indicate that the contractor is also the owner and/or builder and a license number area 1632 to place the license number of the contractor.

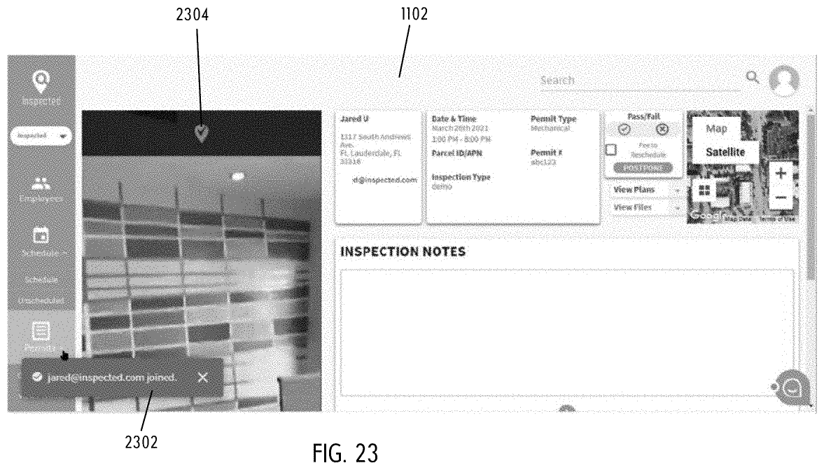

Referring now to FIG. 20, the permit application entry portion 1602 includes a fourth architect and/or engineer information section 1634 for entering the information of the associated architect and/or engineer related to the permit application, including the name, phone number, email address, and physical address.

Still referring to FIG. 20, an inspection type section 1636 is provided that allows for each type of inspection type to be populated and an inspector and/or an inspector group to be assigned. The inspection type 1640 is selected and the associated inspector dropdown area 1642 will populate with those inspectors that qualify to perform the type of inspection selected. For example, an inspector may only be qualified to perform electrical inspections and HVAC inspections. Therefore, in this example, the inspector dropdown area 1642 will provide a list of inspectors and/or inspector groups that are qualified to perform the type electrical and HVAC inspections and will hide all other unqualified inspectors from being selectable. In this operation, only those inspectors that are qualified to perform the inspection will be allowed to be placed onto a permit application for future inspection. Multiple inspections can be added to the permit application via a add inspection type button 1646. At the conclusion of entering the information into the permit application entry portion 1602 a user may save the permit by selecting the save permit button 1644. The operation of selecting the save permit button 1644 will create a new permit in the system and allow for the person seeking the permit to select a virtual permit inspection at a time in the future and as described further herein.

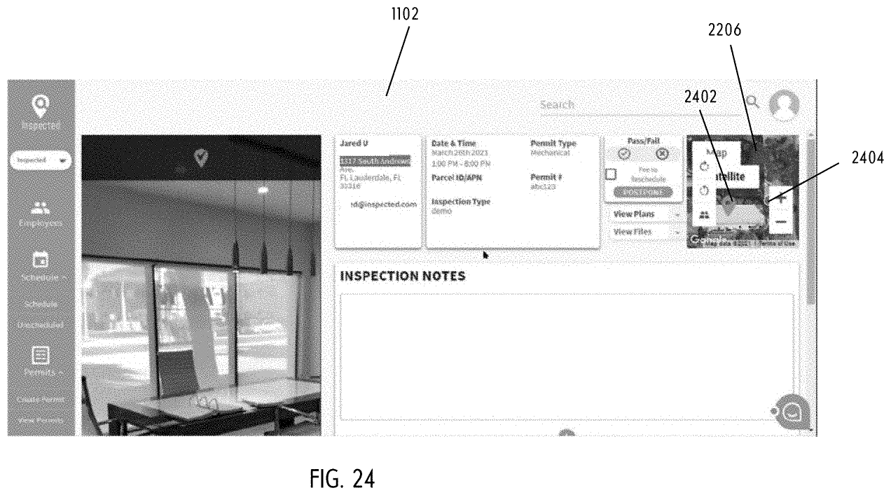

Referring now to FIG. 21, the inspector calendar 1002 is provided with an exemplary schedule view for remotely inspecting a property to pass or fail an attempt to close a permit. The schedule view allows the selection of the remote inspector to join the remote selection via selection options 1004. The schedule view displays the inspector calendar 1002 with a dropdown menu 2102 for selecting all inspection types and/or narrowing down the inspection types to a specific inspection type specified for the creation of the permit with the inspection type 1640 selection area. The calendar may be toggled between different days, weeks and/or month views, or any other conceivable view of the upcoming and/or past inspections. The inspector calendar 1002 when in a day view includes a toggle for toggling between different inspection dates.

Referring to FIGS. 20-21, in one non-limiting embodiment, the selection of a specific inspector and/or inspector is not required for creating the permit in the inspector selection area 1642. When the selection of a specific inspector and/or inspector group is not selected at area 1642, the inspector(s) may join an inspection not assigned to them by selecting the type of inspection they seek to view on the dropdown filter menu 2102 and then subsequently selecting the particular selection option 1004 of the virtual inspection on the calendar that inspector wishes to join.

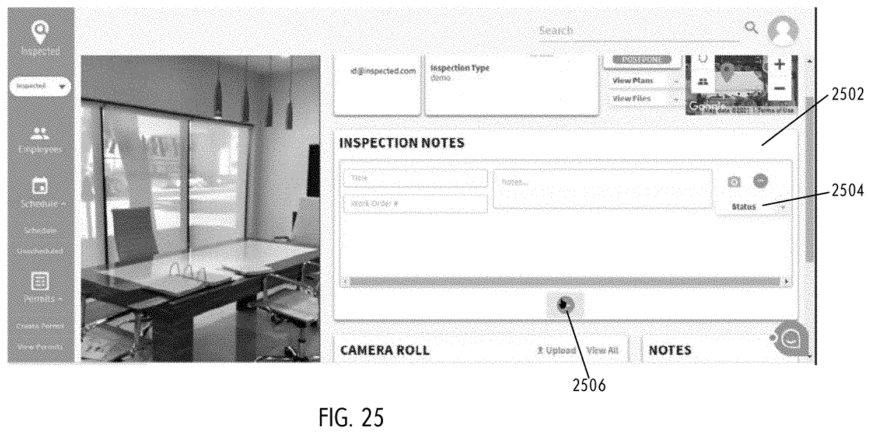

Referring now to FIG. 22, the inspector control panel 1102 is provided such that a user selects the particular inspection 1004 from the list on the calendar to start the virtual inspection. The inspection control panel initially provides a start video call button that allows the inspector to initiate a virtual inspection with one or more mobile device 102. As shown in FIG. 22 before connecting with one or more mobile device 102, the geolocation verification icon automatically displays indicating that the one or more mobile device 102 are not verified to be geolocated within a determined proximity of the inspection address. In a non-limiting embodiment, the inspector is provided with the ability to override the geolocation verification.

Still referring to FIG. 22, inspection control panel 1102 includes a map 2206. The inspection control panel 1102 includes the contact information of the person(s) associated with the virtual inspection site 2208. The inspection control panel 1102 includes a permit information section 2210 that includes information regarding the inspection site, including the location, including without limitation parcel ID/APN and/or folio number and/or permit type and/or permit number and/or inspection type.

Still referring to FIG. 22, the inspection control panel 1102 provides a section for viewing the plans and/or other files attached via the plan attachment area 1618 and file attachment area 1620 when the job is created.

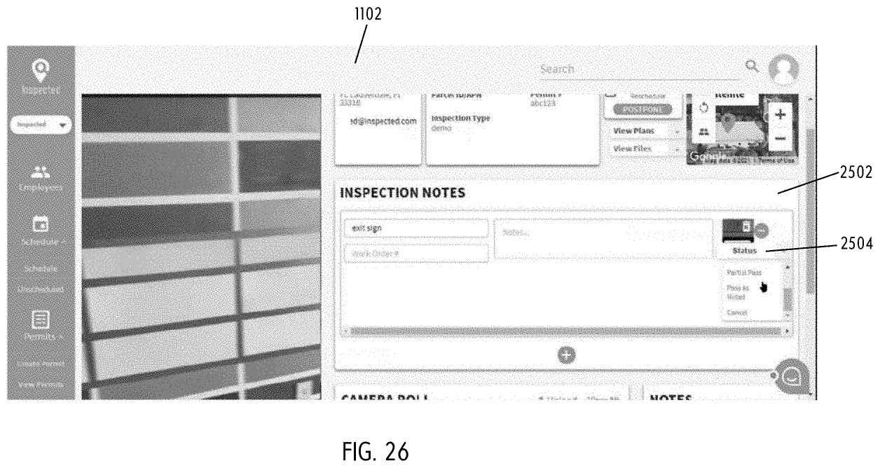

Referring now to FIG. 23, the inspection control panel 1102 indicates when the remote mobile device 102 joins the remote inspection 2302. The inspection control panel 1102 verifies the geolocation of the one or more mobile device 102 and indicates when the one or more mobile device 102 are within a proximity of the inspection location. Once the geolocation of the one or more mobile device 102 involved in the remote inspection are verified to be within a proximity of the inspection location, an indicator 2304 will positively display on the inspection control panel 1102 to indicate that the one or more mobile device 102 are within the determined proximity to the inspection site to verify that the one or more mobile device 102 sharing their screen to the inspector are within the location required for the inspection, thereby preventing fraudulent compliance with permit requirements. The video camera from the one or more mobile device 102 are displayed on the inspection control panel 1102. The video from the one or more mobile device 102 are automatically recorded when the connection with the video feed from the one or more mobile device 102 occurs.

In a non-limiting embodiment, the geolocation of the one or more mobile device 102 will automatically share geolocation one or more times during the inspection for continuing to verify the location of the one or more mobile device 102 throughout the virtual inspection.

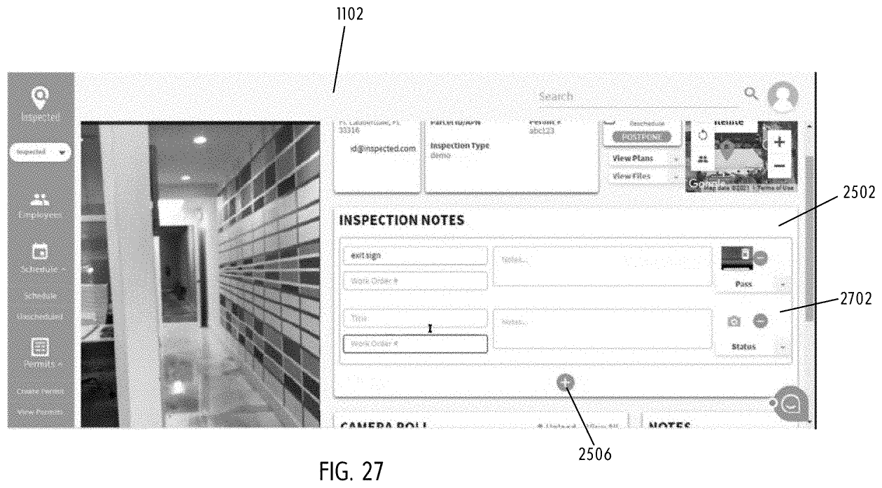

Referring now to FIG. 24, inspection control panel 1102 automatically displays the map 2206 with a location pin 2402 of the location of the virtual inspection as determined via the location provided during the submission of the creation of the permit shown in FIGS. 16-20. The map 2206 further provides the visual location of the one or more mobile device 102 via one or more mobile device indictors 2404 that are automatically provided in real time on the map to allow the inspector see in real time the location of one or more mobile device 102 involved in the virtual inspection. In the instant embodiment shown in FIG. 24, the map is provided with a single indictor indicia 2404 indicating the location of the one mobile device 102 in visual relation to the inspection site 2402 allowing the inspector to see and/or monitor whether the person seeking to close the permit is in the location that is required by the permit to create trust in the virtual permit process and/or to prevent fraud in the virtual permit inspection process.

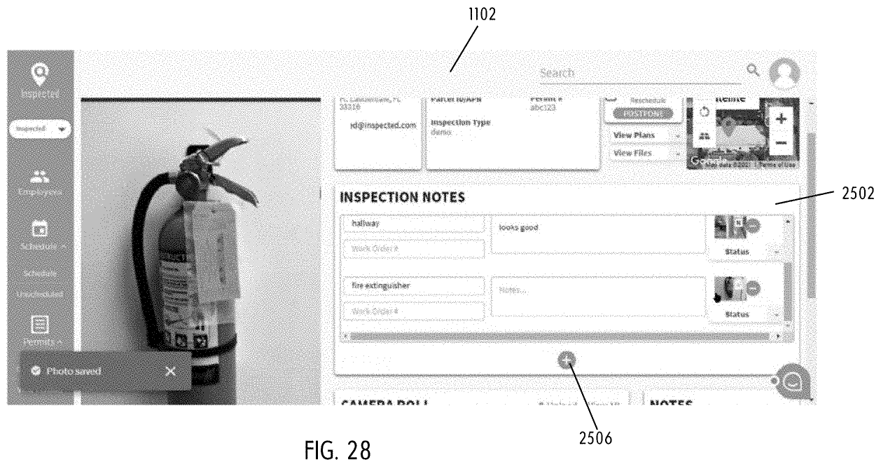

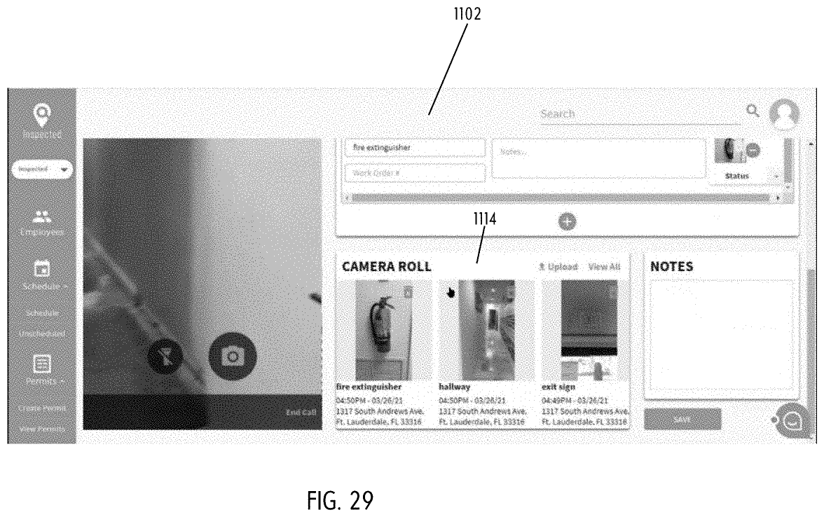

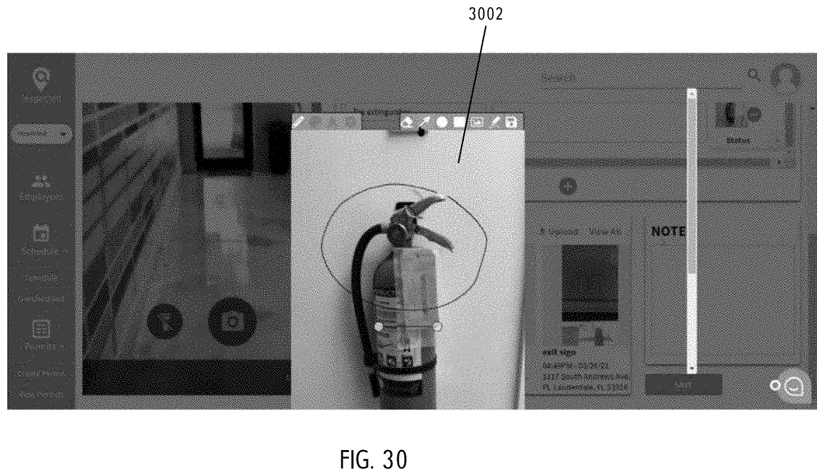

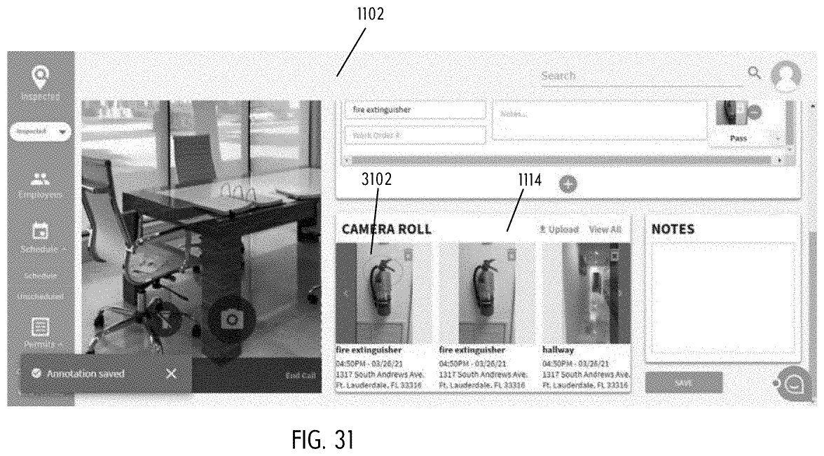

Referring now to FIGS. 25-28, in one non-limiting embodiment of the present invention, inspection control panel 1102 provides an inspection notes section 2502 that allows the virtual inspector to make notes and take capture pictures from the one or more mobile device 102 during the live feed of the virtual inspection. The inspection notes section 2502 includes a status indicator selection portion 2504 with pass/fail selection indicia (See FIG. 26). The pass/fail selection indicia may include selections for pass, fail, partial pass, pass as noted, or other desired indications pass/fail type status indications (See FIG. 26). The inspection notes section 2502 includes a button 2506 to populate additional lines of notes, such that selecting button 2506 will populate an additional set 2702 of inspection notes (See FIGS. 27-28). In operation, the inspector will add additional lines to the inspection notes section 2502 for adding additional titles, work order numbers, notes, pictures, and individual pass/fail indications related to the specific section. In this manner, the inspection notes section 2502 may include numerous indications where some may be selected as passed and some may be selected as failed, including that a specific portion of the inspection that failed to pass the inspection.

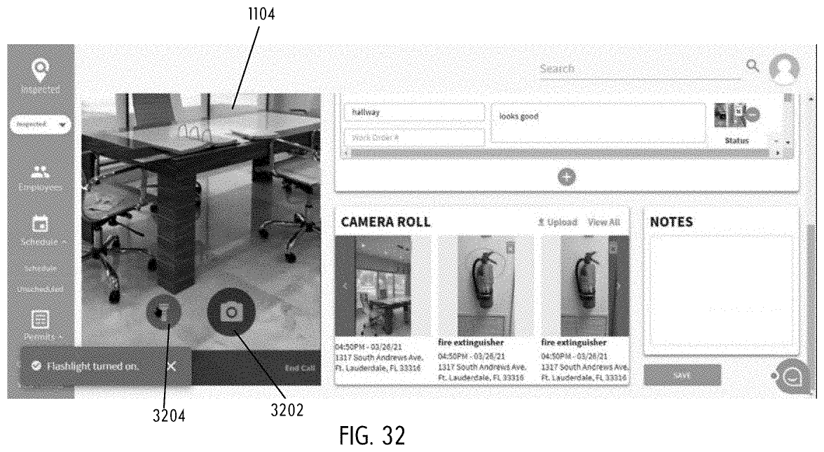

Referring now to FIG. 29, the inspection control panel 1102 is provided with the camera roll section 1114 for displaying and organizing all pictures captured during the virtual inspection. The pictures are captured with date and time stamp, along with geolocation date provided by the mobile device 102 from which the image was generated by the camera on the mobile device 102.

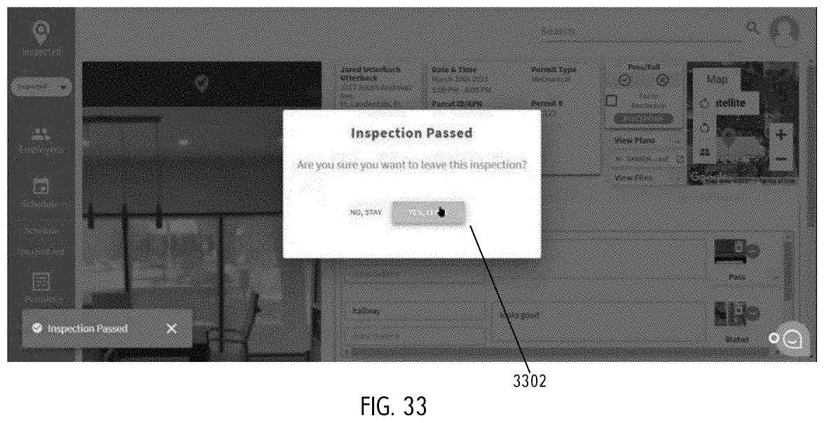

Referring now to FIG. 30, when the user selects the pictures in the camera roll, the selected picture is shown in an annotation window 3002. The annotation window provides various drawing features, such as draw, arrow, circle, or any other picture annotation features.

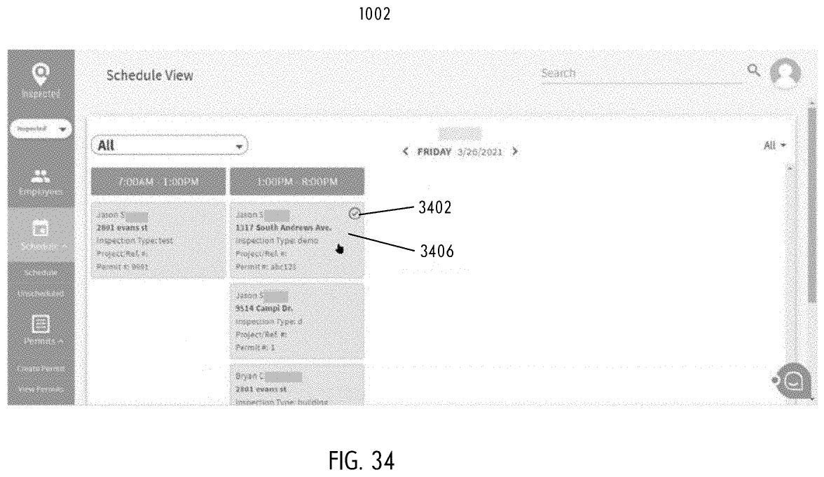

Referring now to FIG. 31, once the virtual inspector optionally annotates a picture and selects to save the picture, within the inspection control panel 1102, a copy 3102 of the picture that was annotated will be saved to the camera roll 1114 for the relevant inspection.

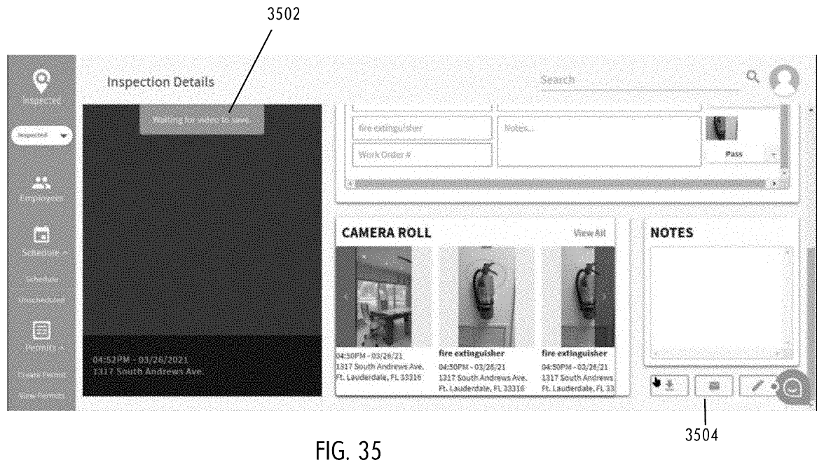

Referring now to FIG. 32, the inspection control panel 1102 includes a camera button 3202 for taking pictures that are placed into the camera roll 1114. The inspection control panel 1102 further includes a flashlight button 3204 that when selected will activate the flashlight of the one or more mobile device 102 for illuminating the image being transmitted to the active screen 1104. In operation, the inspector can shine a light to assist in the virtual inspection in areas that are dim or poorly lit. Likewise, the flashlight button that can be selected by the virtual inspector on the inspection control panel 1102 allows the virtual inspector to take and save illuminated pictures and/or video during the virtual inspection.

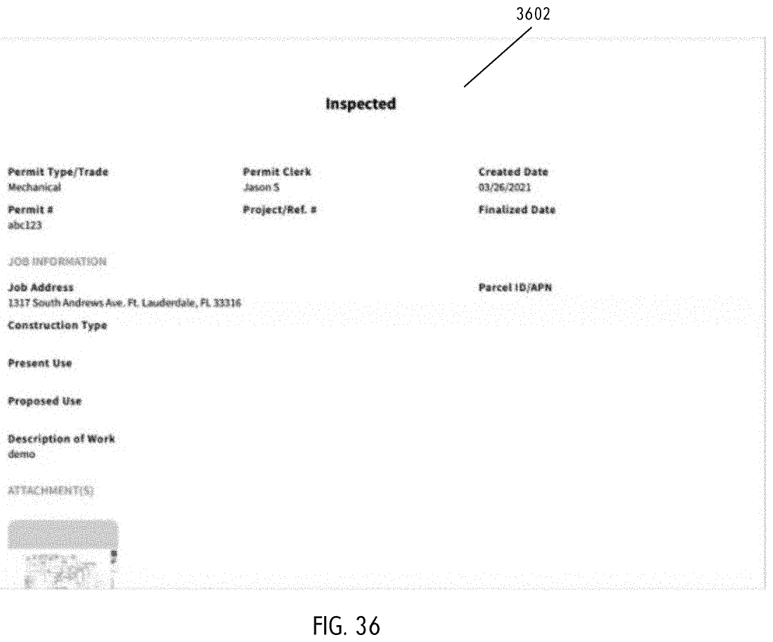

Referring now to FIG. 33, the inspection control panel 1102 includes a confirmation 3302 to leave or stay in the virtual inspection session once the virtual inspector selects the pass/fail selection indicia 1120.

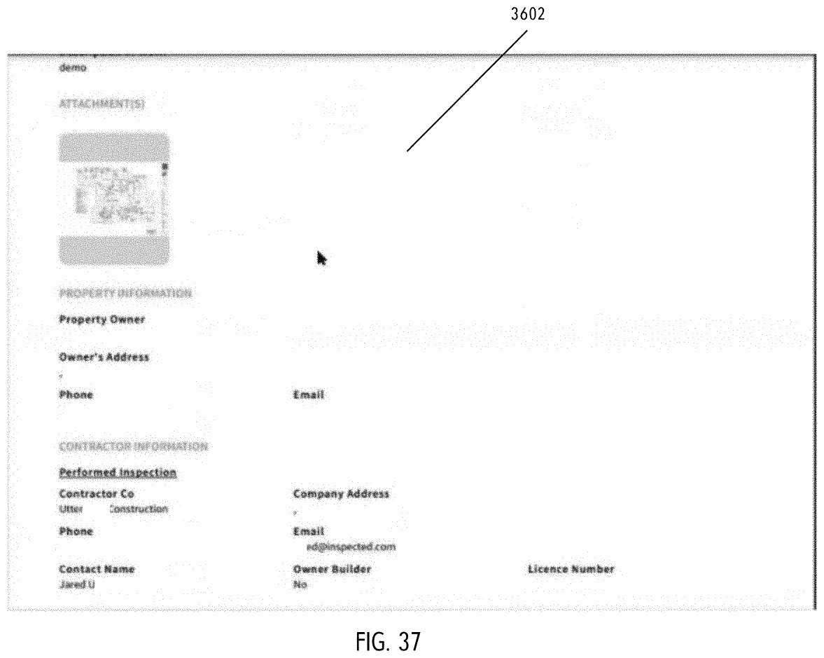

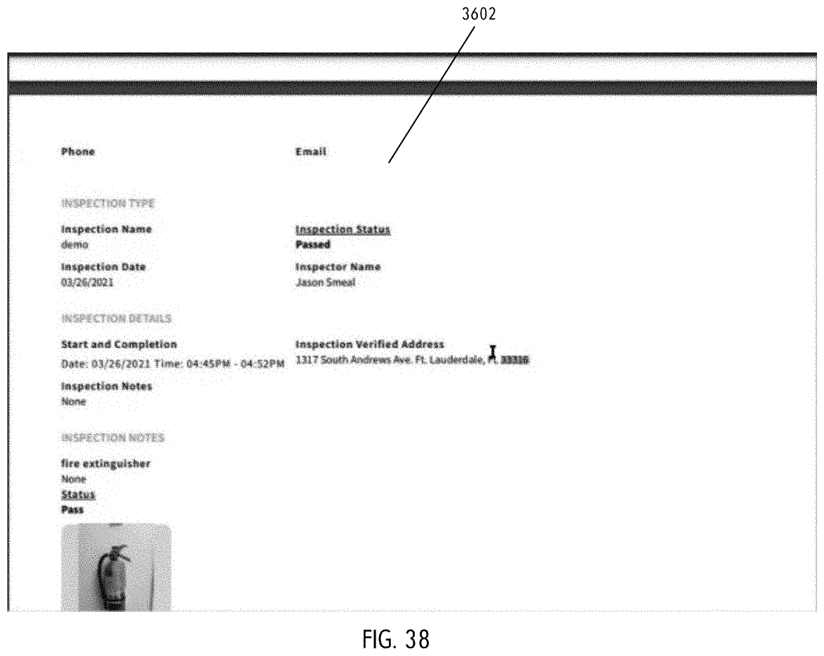

Referring now to FIG. 34, the schedule scheduled inspection 1004 on the inspector calendar 1002 visually indicates via pass/fail indicia 3402 whether the inspection passed or failed during this scheduled virtual inspection. When a user selects the completed virtual inspection 3406 as shown in FIG. 34, the user is brought into the inspection control panel 1102 as shown in FIG. 35.

Referring now to FIG. 35, the completed virtual inspection 3406 is provided shortly after the virtual inspection such that the inspection control panel 1102 indicates 3502 that the video from the recently completed virtual inspection is continuing to save to the server. The inspection control panel 1102 further provides an access report section 3504 with options to access a report generated automatically following the virtual inspection. From the access report section 3504, selecting the download, mail, or edit feature will allow the user to download, email, or edit the inspection report.

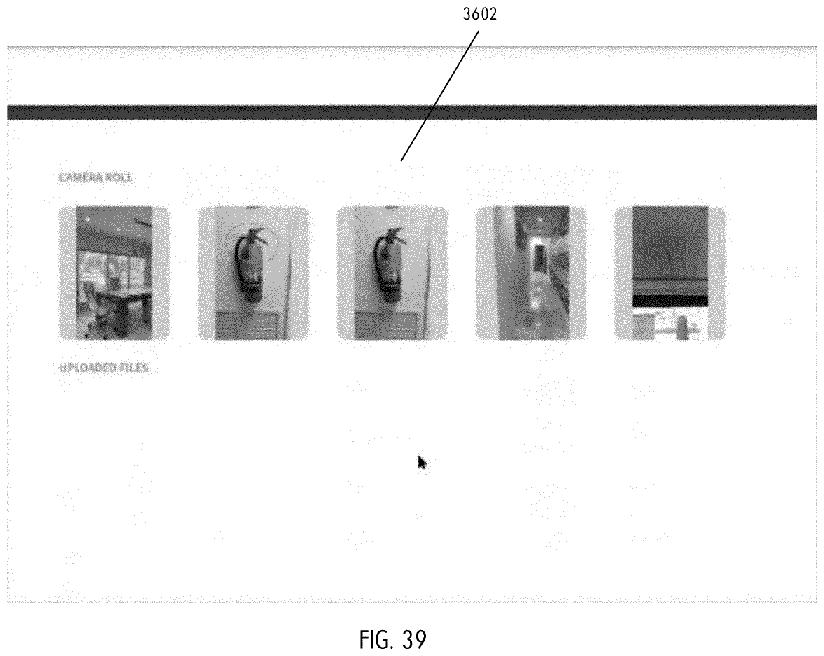

Referring now to FIG. 36-39, an exemplary inspection report 3602 is provided subsequent to selecting from the access report section 3504. The inspection report 3602 includes information from the virtual inspection, including without limitation access to attachments, plans, and inspection location information, such as address and/or folio information, pictures.

It is within the spirit and scope of the instant embodiment to store the remote inspection data, includes notes, pass/fail, pictures, fields, notes, and/or customizable fields from the inspection control panel 1102 within the inspection database 110. All or portions of the remote inspection data may be stored, or reflected in the public record database 114 following the completion of the remote inspection, including geo location of the mobile device 102 involved in the section, and also the results of closing of permits relating to the remote inspection, or that the inspection itself was performed remotely.

It is within the spirit and scope of the instant embodiment that the remote inspection system 100 is intended to be used for closing permits, however, the system may be implemented across a variety of other inspections, including construction related site verification and/or inspection; government or city address or location inspection; short term rental property inspection and/or verification of addresses for vendors, such as Uber, VRBO, AirBNB to ensure that the address listed on the site is consistent with property listed for rent; rental and lease property close out and/or removal inspections; property foreclosure inspections for banks and/or other financial institutions; consumer and/or commercial financing for jobsite and/or address verification; medical office and/or retirement home verification and/or inspections; taxi and/or ride share services to verify location and/or address of residence; police and/or criminal justice verification for house arrest and other legal uses; military site and/or venue inspection for government agencies; commercial site inspection for property maintenance; grow dispensary site location or inspection; fire/code inspection for buildings and locations; insurance inspection for insurance claims and/or initial coverage inspections; site surveys and/or land surveys and/or valuations; any other remote inspection that would require verification of an address during the inspection process.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure.

What is claimed is:

1. A method of virtual inspection of a permit location performed on a non-transitory computer-readable medium comprising:
providing a virtual inspection control panel for displaying a virtual permit inspection of a first mobile device;
acquiring geolocation data from a first mobile device;
automatically comparing the geolocation data from the first mobile device against the permit location; and
displaying an indictor on the virtual inspection control panel indicating whether the first mobile device is located within a proximity to the permit location.

2. The method of virtual inspection of a permit location performed on a non-transitory computer-readable medium of claim 1, further comprising receiving to the virtual inspection control panel a live video stream from a camera located on the first mobile device.

3. The method of virtual inspection of a permit location performed on a non-transitory computer-readable medium of claim 2, further comprising:
selecting to start of the virtual inspection; and
automatically notifying on the first mobile device of the start of the virtual inspection upon said selection of the start of the virtual inspection.

4. The method of virtual inspection of a permit location performed on a non-transitory computer-readable medium of claim 2, further comprising providing an inspection notes section.

5. The method of virtual inspection of a permit location performed on a non-transitory computer-readable medium of claim 4, wherein said provided inspection notes section includes a camera shutter feature to store a live geolocated picture from the camera of the first mobile device.

6. The method of virtual inspection of a permit location performed on a non-transitory computer-readable medium of claim 5, wherein said provided inspection notes section includes at least one individual notes section with a selectable portion capable of indicating one of at least pass and fail.

7. The method of virtual inspection of a permit location performed on a non-transitory computer-readable medium of claim 5, wherein said provided inspection notes section includes a plurality of notes sections each with an option to take a live geolocated picture from the camera of the first mobile device and wherein each of the plurality of notes sections include a selectable portion capable of indicating one of at least pass and fail.

8. A method of virtual inspection of a permit site performed on a non-transitory computer-readable medium comprising:
using a virtual inspection control panel for displaying a virtual permit inspection of a first mobile device;
acquiring geolocation data from a first mobile device; and
automatically determining whether the first mobile device is located within a predetermined virtual permit inspection site.

9. The method of virtual inspection of a permit site performed on a non-transitory computer-readable medium of claim 8, further comprising storing to a cloud storage site indication of whether the first mobile device was located within the predetermined virtual permit inspection site during at least a portion of the virtual inspection.

10. The method of virtual inspection of a permit site performed on a non-transitory computer-readable medium of claim 8, further comprising indicating visually on the virtual inspection control panel whether the first mobile device is located within the predetermined virtual permit inspection site during at least a portion of the virtual inspection.

11. A system for virtual inspection of a permit location comprising:
a virtual inspection control panel for displaying a virtual permit inspection facilitated by a first mobile device, wherein said virtual inspection control panel visually indicates whether a first mobile device is located within a pre-determined proximity to the permit location.

12. The system for virtual inspection of a permit location of claim 11, further comprising a camera roll within said virtual inspection control panel, wherein said virtual inspection control panel capable of taking live geolocated pictures from the camera of the first mobile device taken during the virtual inspection.

13. The system for virtual inspection of a permit location of claim 11, wherein said virtual inspection control panel includes selectable indicia capable of indicating at least between pass and fail of the virtual inspection.

14. The system for virtual inspection of a permit location of claim 13, wherein said virtual inspection control panel includes a live geolocated video feed section displaying live video received from a camera on the first mobile device.

15. The system for virtual inspection of a permit location of claim 13, wherein said virtual inspection control panel capable of initiating an on/off of a light on the first mobile device.

16. The system for virtual inspection of a permit location of claim 13, further comprising a report generation portion that automatically provides a downloadable report following a conclusion of the virtual inspection.

17. The system for virtual inspection of a permit location of claim 13, wherein said virtual inspection control panel provides an annotation section for annotating captured pictures from the first mobile device.
